(19) United States
(12) Patent Application Publication
(10) Pub. No.: US 2025/0296226 A1
(43) Pub. Date: Sep. 25, 2025

(54) ROBOT

(71) Applicant: SEIKO EPSON CORPORATION, Tokyo (JP)

(72) Inventors: Eiji INOMATA, MATSUMOTO-SHI (JP); Takuya OWA, MATSUMOTO-SHI (JP); Akio NIU, MATSUMOTO-SHI (JP); Naoki TSUKAHARA, MATSUMOTO-SHI (JP)

(21) Appl. No.: 19/084,502

(22) Filed: Mar. 19, 2025

(30) Foreign Application Priority Data
Mar. 21, 2024 (JP) 2024-044608

(51) Int. Cl. B25J 9/10; B25J 9/12; B25J 13/00

(52) U.S. Cl. CPC B25J 9/102; B25J 9/12; B25J 13/00

(57) ABSTRACT

A robot includes a base, a robot arm rotating relative to the base, a reducer coupling the base and the robot arm, a motor coupled to the reducer, a control board controlling driving of the motor, and a power supply board supplying electric power to the control board, in which the base includes a first housing to which at least one of the reducer, the motor, the control board, and the power supply board is attached, and a second housing to which at least one of the reducer, the motor, the control board, and the power supply board excluding the at least one attached to the first housing is attached.

### CROSS-REFERENCE TO RELATED APPLICATIONS

The present application is based on, and claims priority from JP Application Serial Number 2024-044608, filed Mar. 21, 2024, the disclosure of which is hereby incorporated by reference herein in its entirety.

### BACKGROUND OF THE INVENTION

### 1. Technical Field

The present disclosure relates to a robot.

### 2. Related Art

A robot described in JP-A-2019-063933 includes a robot body including a base and a robot arm displaceably connected to the base. The robot arm includes a first arm rotatably connected to the base, a second arm rotatably connected to the first arm, a third arm rotatably connected to the second arm, a fourth arm rotatably connected to the third arm, a fifth arm rotatably connected to the fourth arm, and a sixth arm rotatably connected to the fifth arm.

The robot described in JP-A-2019-063933 further includes a reducer that rotatably connects the base and the first arm, and a motor that rotates the first arm via the reducer, and the reducer and the motor are housed together in the base. In addition, the base also houses a control board for controlling driving of the robot body, a power supply board for supplying electric power to the control board, and a driving board for driving the motor disposed in each arm based on a command from the control board.

A configuration in which a large number of components are housed in the base as described above has a problem in that the components interfere with each other, which makes it difficult to attach and detach the components.

### SUMMARY OF THE INVENTION

According to an aspect of the present disclosure, a robot includes: a base; a robot arm rotating relative to the base; a reducer coupling the base and the robot arm; a motor coupled to the reducer; a control board controlling driving of the motor; and a power supply board supplying electric power to the control board, in which the base includes a first housing to which at least one of the reducer, the motor, the control board, and the power supply board is attached, and a second housing to which at least one of the reducer, the motor, the control board, and the power supply board excluding the at least one attached to the first housing is attached.

According to an aspect of the present disclosure, a robot includes: a base; a robot arm rotating relative to the base; a reducer coupling the base and the robot arm; a motor coupled to the reducer; a control board controlling driving of the motor; a power supply board supplying electric power to the control board; and a fan, in which the base includes a first housing to which at least one of the reducer, the motor, the control board, the power supply board, and the fan is attached, and a second housing to which at least one of the reducer, the motor, the control board, the power supply board, and the fan excluding the at least one attached to the first housing is attached.

### BRIEF DESCRIPTION OF DRAWINGS

FIG. 1 is a side view of a robot according to a first embodiment.

FIG. 2 is a cross-sectional view of a base when viewed from a positive side in an X-axis direction.

FIG. 3 is a cross-sectional view of the base when viewed from a negative side in a Y-axis direction.

FIG. 4 is a cross-sectional view for describing an assembly procedure for the base.

FIG. 5 is a cross-sectional view for describing the assembly procedure for the base.

FIG. 6 is a cross-sectional view for describing the assembly procedure for the base.

FIG. 7 is a cross-sectional view for describing the assembly procedure for the base.

FIG. 8 is a cross-sectional view for describing the assembly procedure for the base.

FIG. 9 is a cross-sectional view for describing the assembly procedure for the base.

FIG. 10 is a cross-sectional view illustrating a modified example of the base.

FIG. 11 is a cross-sectional view illustrating the modified example of the base.

FIG. 12 is a cross-sectional view illustrating the modified example of the base.

FIG. 13 is a cross-sectional view illustrating the modified example of the base.

FIG. 14 is a cross-sectional view of a base included in a robot according to a second embodiment.

FIG. 15 is a cross-sectional view for describing an assembly procedure for the base.

FIG. 16 is a cross-sectional view for describing the assembly procedure for the base.

FIG. 17 is a cross-sectional view for describing the assembly procedure for the base.

FIG. 18 is a cross-sectional view of a base included in a robot according to a third embodiment.

### DETAILED DESCRIPTION OF THE INVENTION

Hereinafter, a robot according to the present disclosure will be described in detail based on embodiments illustrated in the accompanying drawings.

### First Embodiment

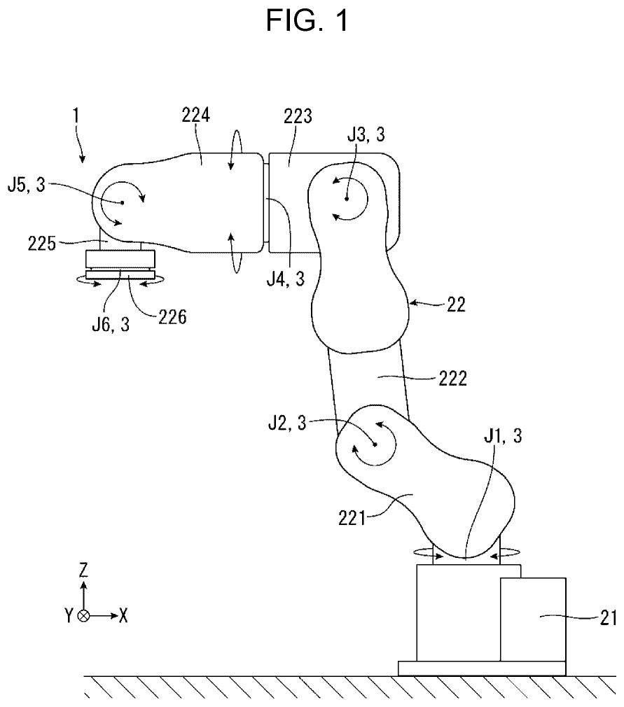

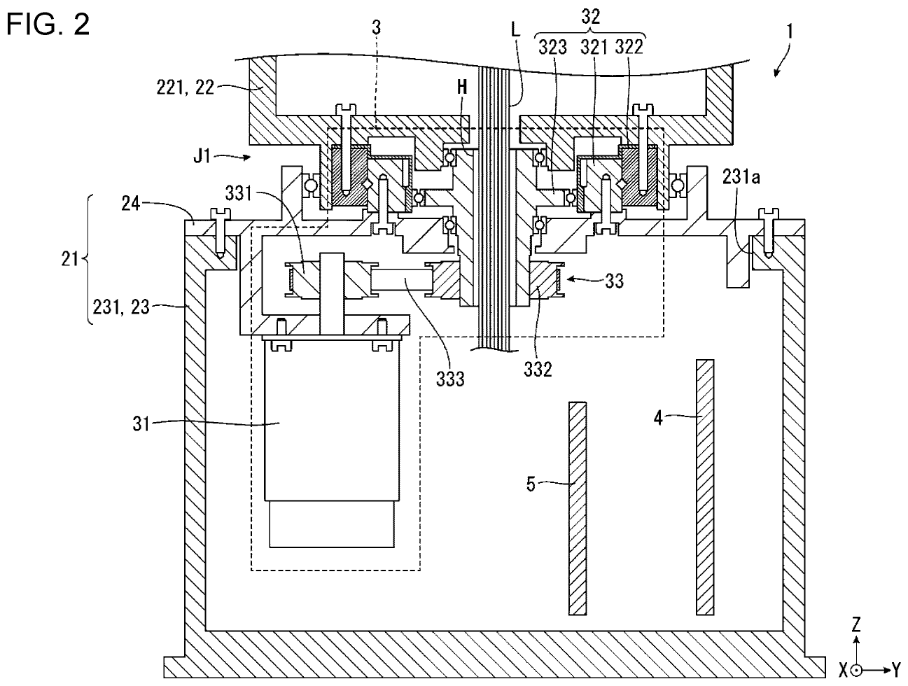

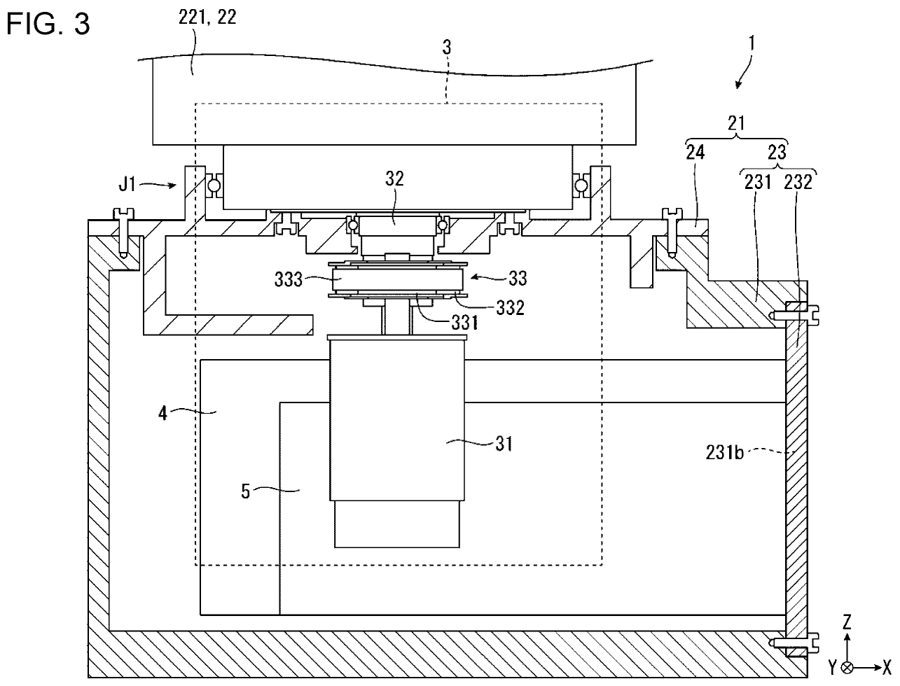

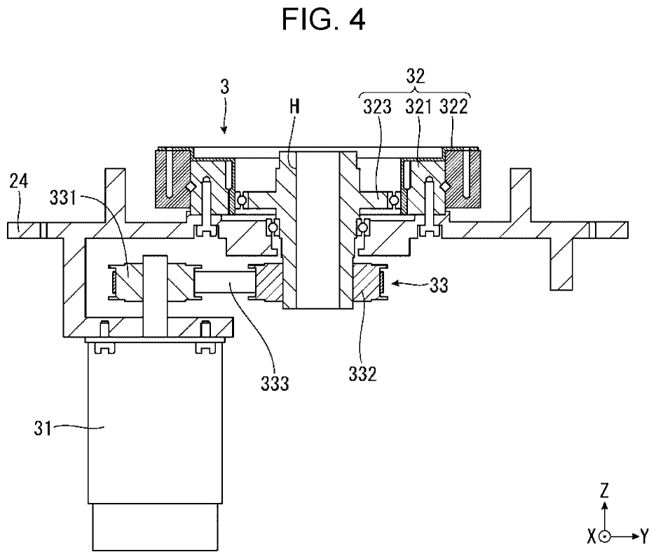

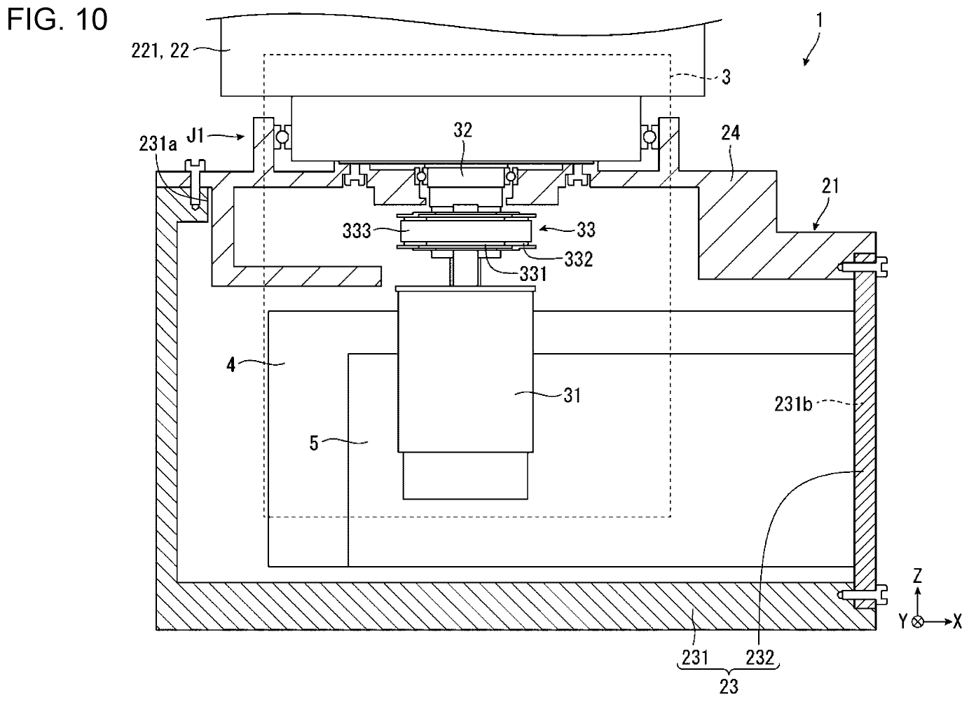

FIG. 1 is a side view illustrating a robot according to a first embodiment. FIG. 2 is a cross-sectional view of a base when viewed from a positive side in an X-axis direction. FIG. 3 is a cross-sectional view of the base when viewed from a negative side in a Y-axis direction. FIGS. 4 to 9 are cross-sectional views for describing an assembly procedure for the base. FIGS. 10 to 13 are cross-sectional views each illustrating a modified example of the base.

As illustrated in FIG. 1, a robot 1 is a six-axis vertical articulated robot having six driving axes, and includes a base 21 fixed to a floor, and a robot arm 22 rotatably connected to the base 21. The robot arm 22 has a configuration in which six arms 221, 222, 223, 224, 225, and 226 are rotatably connected in this order from the base 21, and includes six joints J1, J2, J3, J4, J5, and J6. Specifically, the arm 221 is rotatably coupled to the base 21 via the joint J1. The arm 222 is rotatably coupled to the arm 221 via the joint J2. The arm 223 is rotatably coupled to the arm 222 via the joint J3. The arm 224 is rotatably connected to the arm 223 via the joint J4. The arm 225 is rotatably coupled to the arm 224 via the joint J5. The arm 226 is rotatably coupled to the arm 225 via the joint J6.

Among the joints J1 to J6, the joints J2, J3, and J5 are bending joints, and the joints J1, J4, and J6 are torsion joints. A drive mechanism 3 including a motor, a reducer that decelerates rotation of the motor to increase a rotational force (torque) and output the rotational force, and an encoder that detects a rotation amount of the motor is provided in each of the joints J1 to J6. As each of the joints J1 to J6 is independently moved, a distal end of the robot arm 22 can be moved in a desired direction at a desired pose and speed.

Hereinabove, an overall configuration of the robot 1 has been briefly described. Next, the base 21 will be described in detail. As illustrated in FIGS. 2 and 3, the drive mechanism 3 for driving the joint J1, a control board 4 for driving each drive mechanism 3, and a power supply board 5 for supplying electric power to the control board 4 are disposed in the base 21. Although not illustrated, there are also other components, a fitting for fixing each component to the base 21, and the like in addition to such main components. Although a large number of components are disposed inside the base 21 as described above, it is necessary to reduce a size of the base 21, for example, to reduce an installation area of the robot 1. Therefore, it is difficult to secure a sufficient space inside the base 21, and there is a possibility that the components interfere with each other, which may make it difficult to attach and detach the components, that is, to assemble or disassemble the base 21. Therefore, in the robot 1, the base 21 is divided into a plurality of housings, and the above-described components are separately attached to the plurality of housings, thereby making it easier to attach and detach each component to the base 21.

The base 21 will be described below in detail, but before that, configurations of the drive mechanism 3, the control board 4, and the power supply board 5 will be described first.

### Drive Mechanism 3

As illustrated in FIGS. 2 and 3, the drive mechanism 3 for driving the joint J1 includes a motor 31 with a built-in encoder, a reducer 32 that decelerate rotation of the motor 31 and outputs the rotation to the arm 221, and a power transmission mechanism 33 that transmits power from the motor 31 to the reducer 32.

The reducer 32 is a hollow reducer having a through-hole H that connects a space inside the base 21 and a space inside the arm 221, and is a harmonic drive gear device in the present embodiment. By using the harmonic drive gear device as the reducer 32, it is possible to reduce backlash in the reducer 32 and to more precisely control movement of the arm 221. However, the reducer 32 is not particularly limited and may be a planetary gear device, a roller cam reduction device, or the like.

The reducer 32 mainly includes a circular spline 321, a flexspline 322, and a wave generator 323. The circular spline 321 is screwed to the base 21, the flexspline 322 is screwed to the arm 221, and the wave generator 323 is coupled to the motor 31 via the power transmission mechanism 33. In particular, in the present embodiment, the wave generator 323 has a tubular shape and has the through-hole H. A wiring L passes through the through-hole H and is routed between the base 21 and the robot arm 22. With such a configuration, the wiring L can be inserted into the joint J1, which makes it easy to route the wiring L. Further, for example, when the wiring L is routed between the base 21 and the robot arm 22 from outside the joint J1, a conduit tube or the like is required to prevent the wiring L from being exposed, which leads to an increase in cost, weight, and unnecessary vibration of the robot 1, as well as a decrease in waterproof and dustproof performance.

Further, the power transmission mechanism 33 includes a first pulley 331 attached to an output shaft of the motor 31, a second pulley 332 attached to the wave generator 323 of the reducer 32, and a belt 333 wound around the first and second pulleys 331 and 332. Therefore, the rotation of the motor 31 is transmitted to the wave generator 323 of the reducer 32 via the first pulley 331, the belt 333, and the second pulley 332, and the wave generator 323 rotates. Furthermore, the flexspline 322 rotates at a predetermined reduction ratio relative to the rotation of the wave generator 323, and as a result, the arm 221 rotates around a rotation axis of the joint J1 relative to the base 21.

A configuration in which the rotation of the motor 31 is transmitted to the reducer 32 via the power transmission mechanism 33 as described above increases the degree of freedom in arrangement of the motor 31. Therefore, the motor 31 can be disposed at a position that does not interfere with the control board 4 and the power supply board 5. In addition, with the power transmission mechanism 33, the motor 31 can be disposed while being horizontally shifted from the reducer 32, so that it is possible to effectively prevent a lower opening of the through-hole H of the reducer 32 from overlapping with and being blocked by the motor 31. As a result, it becomes easier to route the wiring L.

In addition, for example, the power transmission mechanism 33 can be used as a reducer by adjusting diameters of the first pulley 331 and the second pulley 332, and a higher reduction ratio can be achieved by using the reducer 32 and the power transmission mechanism 33.

The drive mechanism 3 has been described above, but the configuration of the drive mechanism 3 is not particularly limited. For example, the reducer 32 does not have to be the harmonic drive gear device. Further, the power transmission mechanism 33 may be omitted, and the output shaft of the motor 31 may be directly attached to the wave generator 323 of the reducer 32.

### Control Board 4

The control board 4 can independently control driving of the motor of the drive mechanism 3 provided in each of the joints J1 to J6. Such a control board 4 includes a substrate on which a wiring is provided, a central processing unit (CPU) which is an example of a processor, a random access memory (RAM), and a read only memory (ROM) in which a program is stored, and the like, the CPU, the RAM, and the ROM being provided on the substrate. The CPU reads and executes the program stored in the ROM, thereby achieving a function of a control unit that controls driving of the robot 1. For convenience of explanation, only the substrate of the control board 4 is illustrated, and the illustration of each part provided on the substrate is omitted. In the present embodiment, the number of control boards 4 is one, but the number of control boards 4 is not limited thereto and may be two or more.

### Power Supply Board 5

The power supply board 5 supplies electric power to the control board 4. The power supply board 5 includes a substrate on which a wiring is provided, and a conversion circuit that is provided on the substrate and converts electric power supplied from the outside into a predetermined value. The conversion circuit varies depending on the configuration of the robot 1, and examples of the conversion circuit include an alternating current (AC)/direct current (DC) conversion circuit that converts an AC signal into a DC signal, and a step-up circuit or step-down circuit that converts a voltage level of a signal. For convenience of explanation, only the substrate of the power supply board 5 is illustrated, and the illustration of each part provided on the substrate is omitted. In the present embodiment, the number of power supply boards 5 is one, but the number of power supply boards 5 is not limited thereto and may be two or more.

The configurations of the drive mechanism 3, the control board 4, and the power supply board 5 have been described above. Next, a configuration of the base 21 and arrangement of the drive mechanism 3, the control board 4, and the power supply board 5 within the base 21 will be described.

As illustrated in FIG. 2, the base 21 includes a box-shaped first housing 23 that forms a bottom portion and a side wall portion of the base 21, and a plate-shaped second housing 24 that forms a top portion of the base 21. Furthermore, as illustrated in FIG. 3, the first housing 23 includes a housing body 231 and a cover member 232. The housing body 231 is a base portion of the base 21 and has a first opening portion 231a opened on an upper surface, and a second opening portion 231b opened on a side surface. In particular, in the present embodiment, the second opening portion 231b is formed on a back surface of the housing body 231, that is, on a surface positioned on the positive side in the X-axis direction. The first opening portion 231a is closed by the second housing 24, and the second opening portion 231b is closed by the cover member 232.

As illustrated in FIG. 2, the second housing 24 is mounted on the upper surface of the housing body 231 and closes the first opening portion 231a. Meanwhile, as illustrated in FIG. 3, the cover member 232 is disposed on the back surface of the housing body 231 and closes the second opening portion 231b. The second housing 24 and the cover member 232 are each fixed to the housing body 231 by screwing. The screwing makes it easy to attach and detach the second housing 24 and the cover member 232 to and from the housing body 231. However, the fixing method is not limited to the screwing, and may be fitting, threading, or the like. Although not illustrated, waterproof and dustproof packing is interposed between the housing body 231 and the second housing 24, and between the housing body 231 and the cover member 232. Therefore, it is possible to effectively prevent moisture, dust, and the like from entering the base 21. However, the waterproof and dustproof packing may be omitted.

Then, as illustrated in FIG. 3, the control board 4 and the power supply board 5 are attached to the cover member 232, and the drive mechanism 3 is attached to the second housing 24. As the drive mechanism 3, the control board 4, and the power supply board 5 are separately attached to the first housing 23 and the second housing 24 as described above, the drive mechanism 3, the control board 4, and the power supply board 5 can be easily attached and detached.

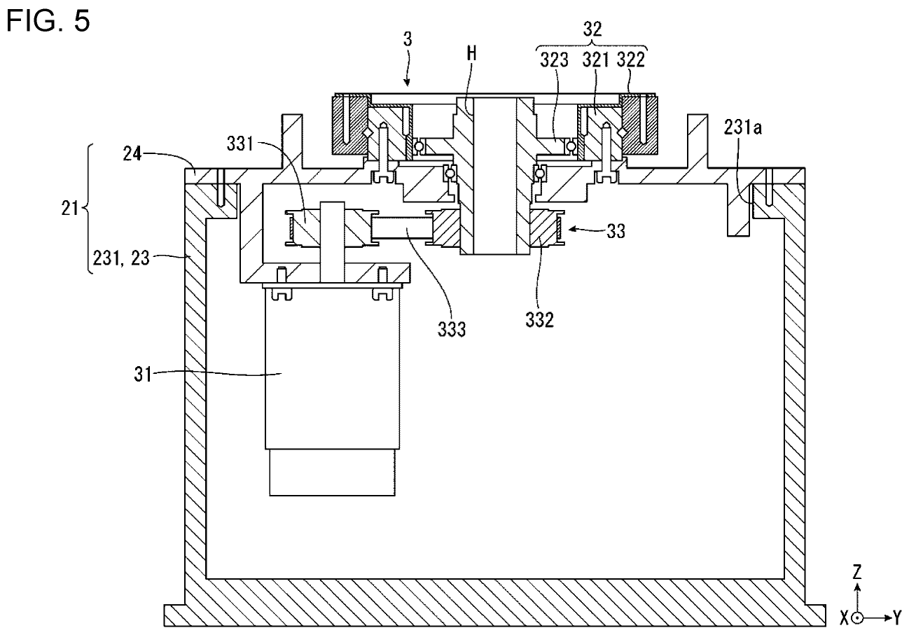

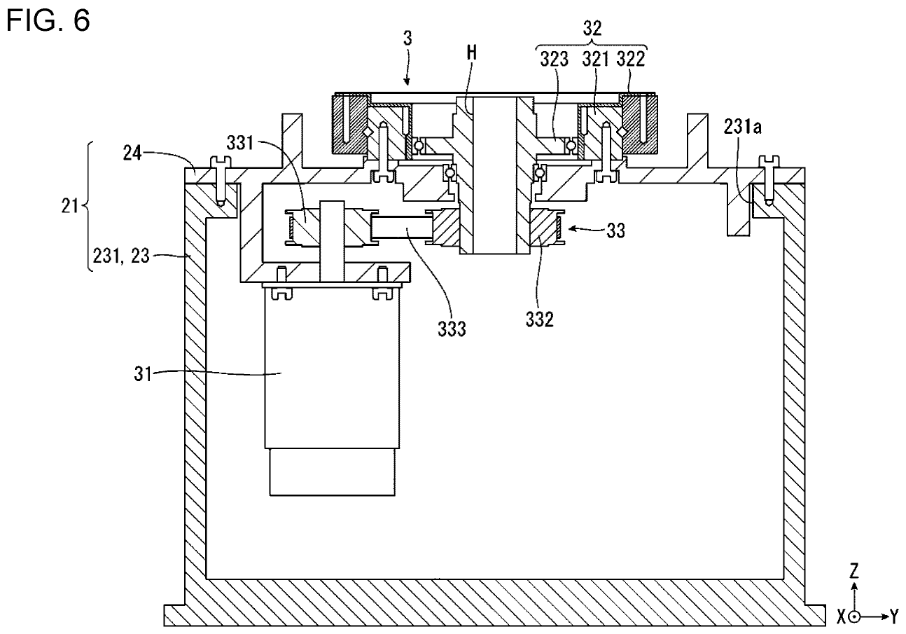

For example, when assembling the drive mechanism 3 to the base 21, it is sufficient if a step of attaching the drive mechanism 3, that is, the motor 31, the reducer 32, and the power transmission mechanism 33, to the second housing 24 removed from the first housing 23 as illustrated in FIG. 4, a step of inserting the drive mechanism 3 into the housing body 231 through the first opening portion 231a and mounting the second housing 24 on the upper surface of the housing body 231 as illustrated in FIG. 5, and a step of screwing the second housing 24 to the housing body 231 to close the first opening portion 231a as illustrated in FIG. 6 are performed. On the other hand, when removing the drive mechanism 3 from the base 21, it is sufficient if a step of removing screws that fix the second housing 24 to the housing body 231 and a step of lifting the second housing 24 and pulling out the drive mechanism 3 from the inside of the housing body 231 through the first opening portion 231a are performed.

As described above, in the robot 1, the drive mechanism 3 can be attached and detached all at once to and from the housing body 231 by attaching and detaching the second housing 24 to and from the housing body 231. As a result, it becomes easy to attach and detach the drive mechanism 3. In addition, the drive mechanism 3 is automatically positioned by screwing the second housing 24 to the housing body 231. Furthermore, since the assembling of the drive mechanism 3 to the second housing 24, and adjustment and maintenance of the drive mechanism 3 can be performed in a state in which the second housing 24 is removed from the housing body 231, that is, in a large space outside the base 21, such actions can be easily and accurately performed. Particularly, in the present embodiment, the second housing 24 can be mounted on the housing body 231. Therefore, the second housing 24 can be easily screwed to the housing body 231.

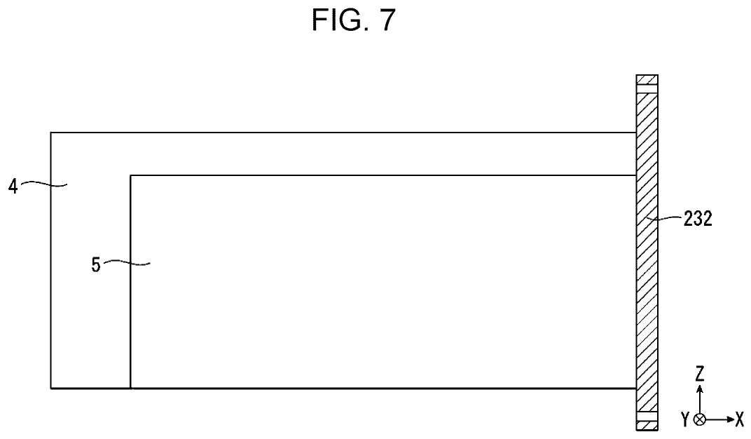

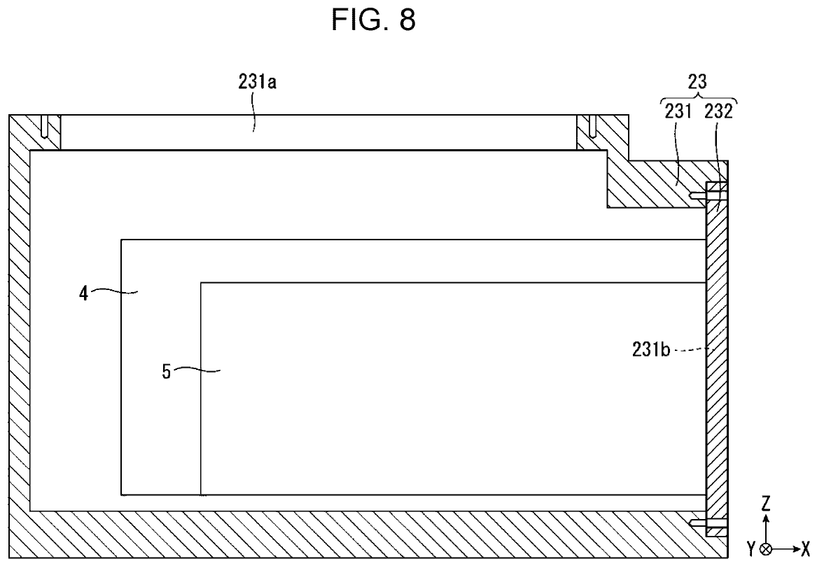

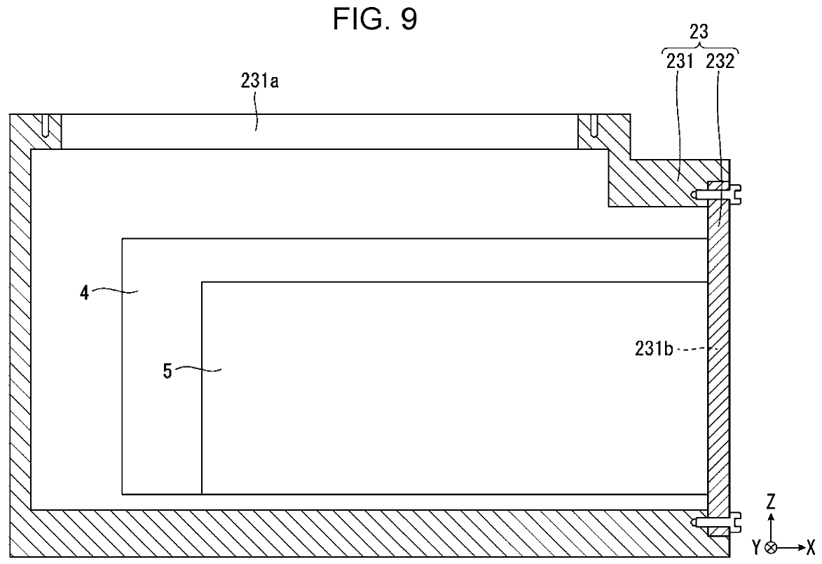

For example, when assembling the control board 4 and the power supply board 5 to the base 21, it is sufficient if a step of attaching the control board 4 and the power supply board 5 to the cover member 232 removed from the housing body 231 as illustrated in FIG. 7, a step of inserting the control board 4 and the power supply board 5 into the housing body 231 through the second opening portion 231b and mounting the cover member 232 on the back surface of the housing body 231 as illustrated in FIG. 8, and a step of screwing the cover member 232 to the housing body 231 to close the second opening portion 231b as illustrated in FIG. 9 are performed. On the other hand, when removing the control board 4 and the power supply board 5 from the base 21, it is sufficient if a step of removing screws that fix the cover member 232 to the housing body 231 and a step of removing the cover member 232 and pulling out the control board 4 and the power supply board 5 from the inside of the housing body 231 through the second opening portion 231b are performed.

As described above, in the robot 1, the control board 4 and the power supply board 5 can be attached and detached all at once to and from the housing body 231 by attaching and detaching the cover member 232 to and from the housing body 231. As a result, it becomes easy to attach and detach the control board 4 and the power supply board 5. In addition, the control board 4 and the power supply board 5 are automatically positioned by screwing the cover member 232 to the housing body 231. Furthermore, since the assembling of the control board 4 and the power supply board 5 to the cover member 232, and adjustment and maintenance of the control board 4 and the power supply board 5 can be performed in a state in which the cover member 232 is removed from the housing body 231, that is, in a large space outside the base 21, such actions can be easily and accurately performed.

Particularly, in the present embodiment, the control board 4 and the power supply board 5 are directly attached to the cover member 232 without using a supporting member such as a fitting. As a result, it is possible to reduce the number of components in the base 21, which in turn creates more space in the base 21, and effectively suppresses interference between the components. However, the present disclosure is not limited thereto, and the control board 4 and the power supply board 5 may each be fixed to the cover member 232 via a supporting member such as a fitting.

The robot 1 has been described above. As described above, such a robot 1 includes the base 21, the robot arm 22 that rotates relative to the base 21, the reducer 32 that couples the base 21 and the robot arm 22, the motor 31 coupled to the reducer 32, the control board 4 that controls the driving of the motor 31, and the power supply board 5 that supplies electric power to the control board 4. The base 21 includes the first housing 23 to which at least one of the reducer 32, the motor 31, the control board 4, and the power supply board 5 is attached, and the second housing 24 to which at least one of the reducer 32, the motor 31, the control board 4, and the power supply board 5 excluding the at least one attached to the first housing 23 is attached. As the reducer 32, the motor 31, the control board 4, and the power supply board 5 are separately disposed in the first housing 23 and the second housing 24 as described above, each component can be easily attached and detached while effectively suppressing interference between the components by attaching and detaching the second housing 24 to and from the first housing 23.

As described above, the control board 4 and power supply board 5 are attached to the first housing 23, and the reducer 32 and the motor 31 are attached to the second housing 24. As the reducer 32 and the motor 31 are attached to the second housing 24 as described above, the reducer 32 and the motor 31 can be attached and detached all at once by attaching and detaching the second housing 24 to and from the first housing 23. Therefore, the assembling, adjustment, and maintenance of the reducer 32 and the motor 31 can be performed in a state in which the second housing 24 is removed from the first housing 23, so that such actions can be easily performed.

As described above, the power transmission mechanism 33 that couples the motor 31 and the reducer 32 and transmits a driving force of the motor 31 to the reducer 32 is further attached to the second housing 24. The power transmission mechanism 33 includes the first pulley 331 coupled to the output shaft of the motor 31, the second pulley 332 coupled to an input side of the reducer 32, and the belt 333 wound around the first pulley 331 and the second pulley 332. Such a configuration increases the degree of freedom in the arrangement of the motor 31, so that the motor 31 can be disposed at a position that does not interfere with other components, particularly, the control board 4 and the power supply board 5.

As described above, the first housing 23 has the first opening portion 231a which is an opening portion closed by the second housing 24, and the reducer 32 and the motor 31 are inserted into the first housing 23 through the first opening portion 231a. With such a configuration, the reducer 32 and the motor 31 can be easily inserted into and removed from the first housing 23.

Furthermore, as described above, the second housing 24 is fixed to the first housing 23 in a state of being mounted on the first housing 23. With such a configuration, it becomes easier to fix the second housing 24 to the first housing 23.

As described above, the reducer 32 is a hollow reducer and includes the wiring L that passes through the reducer 32 and is routed between the base 21 and the robot arm 22. With such a configuration, it becomes easier to route the wiring L.

The robot 1 according to the present embodiment has been described above, but the configuration of the robot 1 is not limited thereto.

For example, in the present embodiment, the control board 4 and the power supply board 5 are attached to the first housing 23, and the drive mechanism 3, that is, the motor 31, the reducer 32, and the power transmission mechanism 33, are attached to the second housing 24, but there is no particular limitation as to whether the drive mechanism 3, the control board 4, and the power supply board 5 are attached to the first housing 23 or the second housing 24. For example, the motor 31, the control board 4, and the power supply board 5 may be attached to the first housing 23, and the reducer 32 may be attached to the second housing 24. Alternatively, the reducer 32, the control board 4, and the power supply board 5 may be attached to the first housing 23, and the motor 31 may be attached to the second housing 24. Alternatively, the reducer 32 may be attached to the first housing 23, and the motor 31, the control board 4, and the power supply board 5 may be attached to the second housing 24. Alternatively, the motor 31 may be attached to the first housing 23, and the reducer 32, the control board 4, and the power supply board 5 may be attached to the second housing 24. Alternatively, the motor 31 and the reducer 32 may be attached to the first housing 23, and the control board 4 and the power supply board 5 may be attached to the second housing 24.

For example, as illustrated in FIG. 10, the first opening portion 231a of the housing body 231 may be formed over the entire upper end portion of the housing body 231. In other words, the entire top portion of the base 21 may be formed by the second housing 24. With such a configuration, the first opening portion 231a can be made larger, and the drive mechanism 3 can be more easily inserted and removed from the housing body 231.

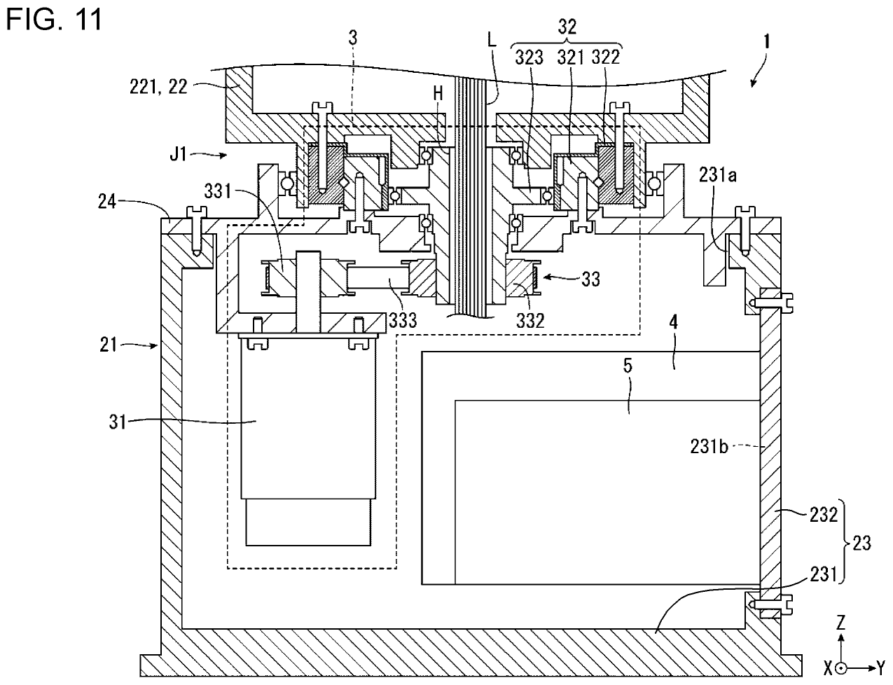

For example, as illustrated in FIG. 11, the second opening portion 231b may be formed on a side wall portion other than the back surface of the housing body 231.

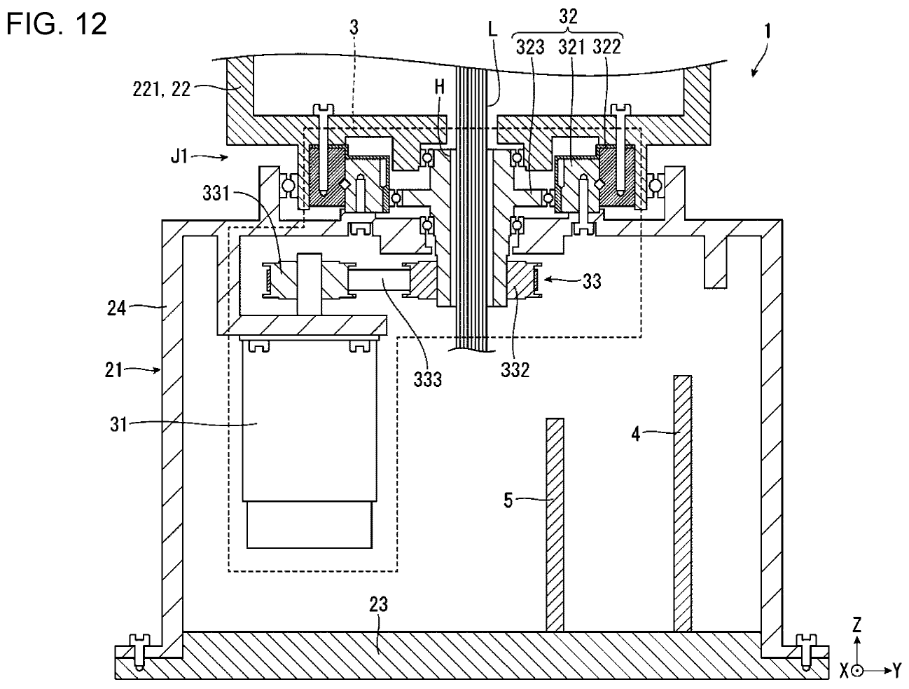

For example, as illustrated in FIG. 12, the first housing 23 may have a plate shape that forms the bottom portion of the base 21, and the second housing 24 may have a box shape that forms the top portion and the side wall portion of the base 21. In this case, the control board 4 and the power supply board 5 are fixed to the upper surface of the first housing 23, and the second housing 24 to which the drive mechanism 3 is attached is placed over and fixed to the first housing 23, thereby housing each of the components within the base 21.

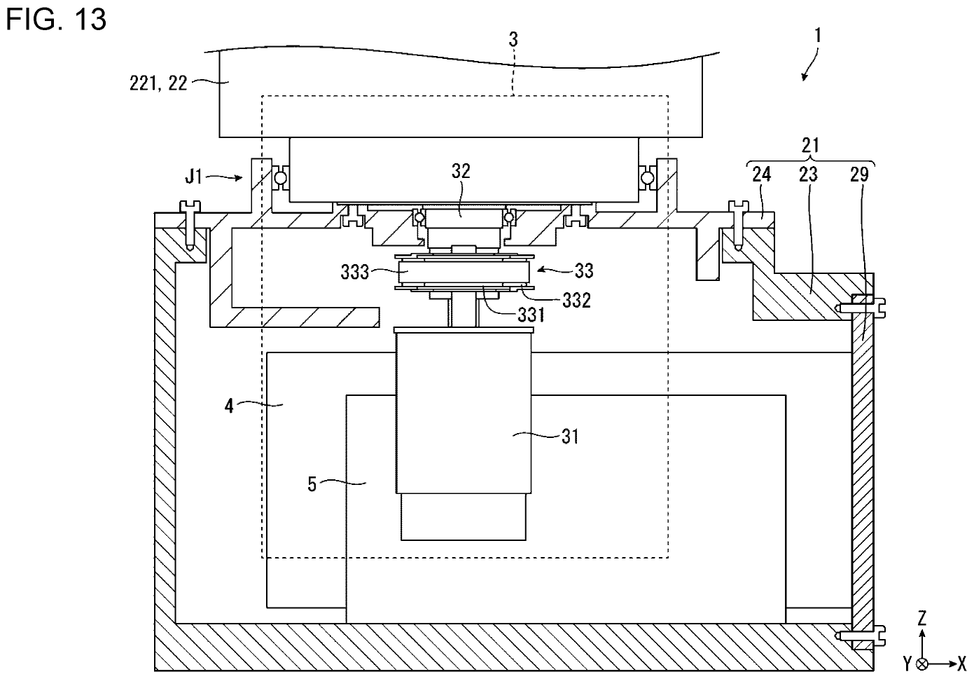

In the present embodiment, the base 21 is divided into the first housing 23 and the second housing 24, but the present disclosure is not limited thereto. For example, as illustrated in FIG. 13, the base 21 may be divided into the first housing 23, the second housing 24, and a third housing 29, and the drive mechanism 3, the control board 4, and the power supply board 5 may be separately attached to the first, second, and third housings 23, 24, and 29. In other words, the base 21 may include the first housing 23 to which at least one of the reducer 32, the motor 31, the control board 4, and the power supply board 5 is attached, the second housing 24 to which at least one of the reducer 32, the motor 31, the control board 4, and the power supply board 5 excluding the at least one attached to the first housing 23 is attached, and the third housing 29 to which the rest of the reducer 32, the motor 31, the control board 4, and the power supply board 5 is attached. In the illustrated example, the power supply board 5 is attached to the first housing 23, the drive mechanism 3 is attached to the second housing 24, and the control board 4 is attached to the third housing 29, but there is no particular limitation as to which housing the drive mechanism 3, the control board 4, and the power supply board 5 are attached to. The base 21 may be divided into a greater number of housings including a fourth housing, a fifth housing, and the like.

### Second Embodiment

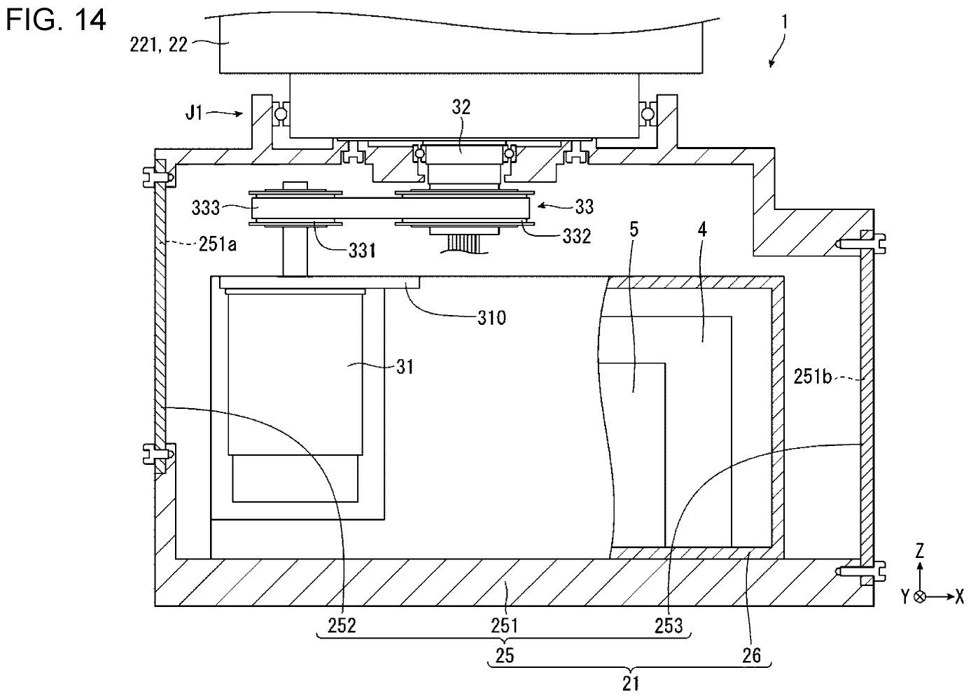

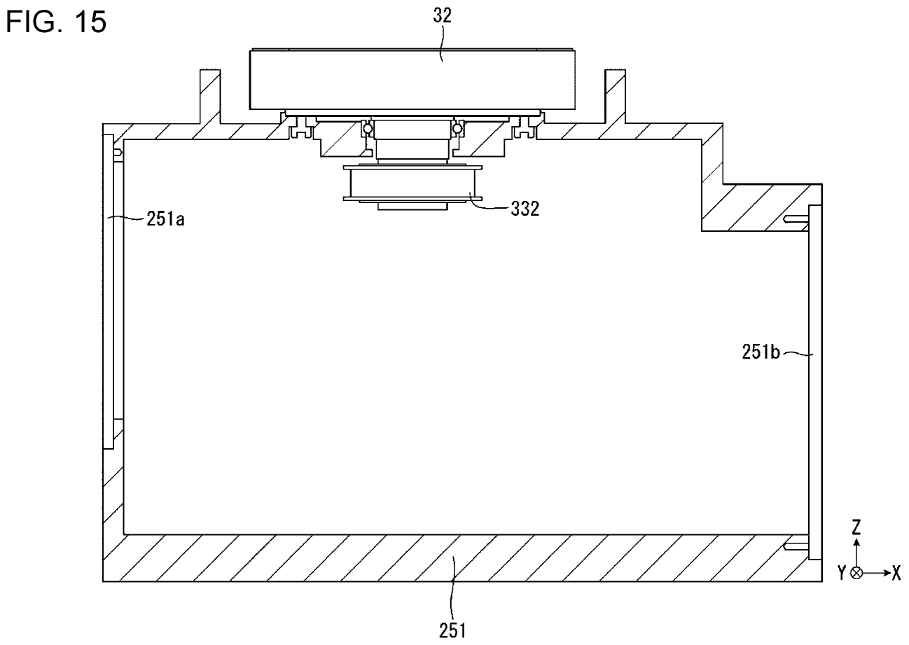

FIG. 14 is a cross-sectional view of a base included in a robot according to a second embodiment. FIGS. 15 to 17 are cross-sectional views for describing an assembly procedure for the base.

A robot 1 according to the present embodiment is similar to the above-described robot 1 according to the first embodiment, except that a configuration of a base 21 is different. In the following description, differences between the robot 1 according to the present embodiment and the robot 1 according to the first embodiment described above will be mainly described, and a description of the similar matters will be omitted. In addition, in each drawing of the present embodiment, the same configurations as those in the above-described embodiment are denoted by the same reference numerals.

As illustrated in FIG. 14, the base 21 included in the robot 1 according to the present embodiment includes an outer housing 25 serving as a first housing, and an inner housing 26 serving as a second housing housed in the outer housing 25. The outer housing 25 includes a box-shaped housing body 251 having a first opening portion 251a opened on a front surface and a second opening portion 251b opened on a back surface, a first cover member 252 that closes the first opening portion 251a, and a second cover member 253 that closes the second opening portion 251b. As described below, the second opening portion 251b is an opening for inserting the inner housing 26 into the outer housing 25, and the first opening portion 251a is an opening for adjusting a tension of a belt 333. The inner housing 26 also has a box shape and has an airtight internal space.

In such a base 21, a reducer 32 is attached to the outer housing 25, and a motor 31, a control board 4, and a power supply board 5 are attached to the inner housing 26. In particular, the control board 4 and the power supply board 5 are each housed in the airtight space within the inner housing 26. Therefore, it is possible to effectively protect the control board 4 and the power supply board 5 from moisture and dust. In contrast, the motor 31 is positioned outside the inner housing 26 and is attached to the inner housing 26 via a motor plate 310. As the motor 31 is disposed outside the inner housing 26 as described above, it becomes easier to wind the belt 333 between the reducer 32 and the motor 31 within the outer housing 25.

In such a configuration of the base 21, a drive mechanism 3, the control board 4, and the power supply board 5 are attached and detached as follows. For example, when assembling the drive mechanism 3, the control board 4, and the power supply board 5 to the base 21, first, the inner housing 26 is pulled out from the outer housing 25, and the reducer 32 is attached to the outer housing 25 as illustrated in FIG. 15. A second pulley 332 is attached to a wave generator 323 of the reducer 32 in advance. By pulling out the inner housing 26 from the outer housing 25 as described above, a large space can be secured within the outer housing 25, and the reducer 32 can be easily attached to the outer housing 25.

Next, each of the control board 4 and the power supply board 5 is attached to a predetermined position within the inner housing 26. Next, the motor 31 is attached to the inner housing 26 via the motor plate 310 on an outer side of the inner housing 26. A first pulley 331 is attached to an output shaft of the motor 31 in advance. According to such a method, since the assembling of the control board 4, the power supply board 5, and the motor 31 to the inner housing 26, and adjustment and maintenance of the control board 4, the power supply board 5, and the motor 31 can be performed in a state in which the inner housing 26 is removed from the outer housing 25, that is, in a large space outside the outer housing 25, these actions can be easily and accurately performed.

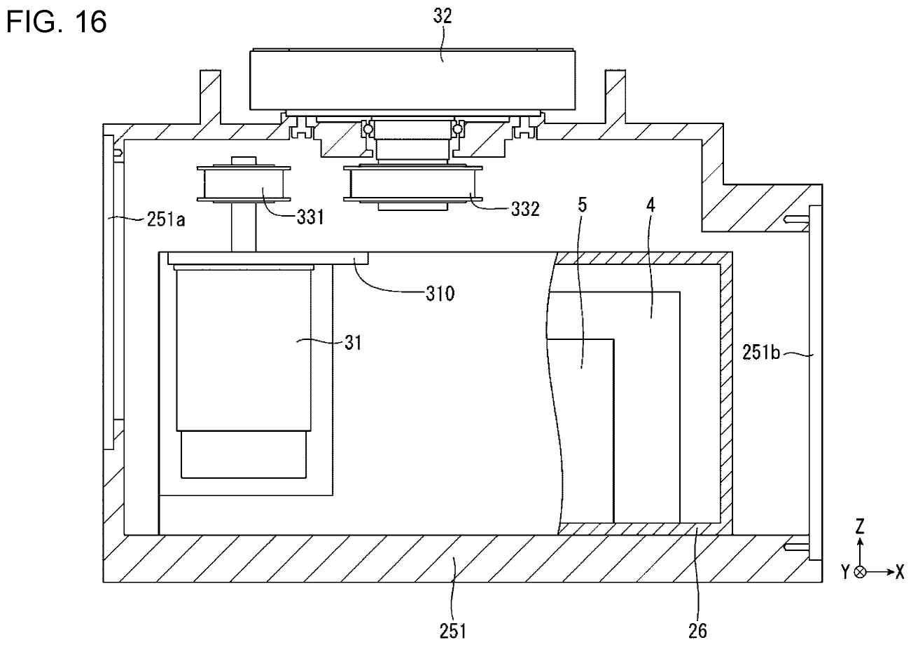

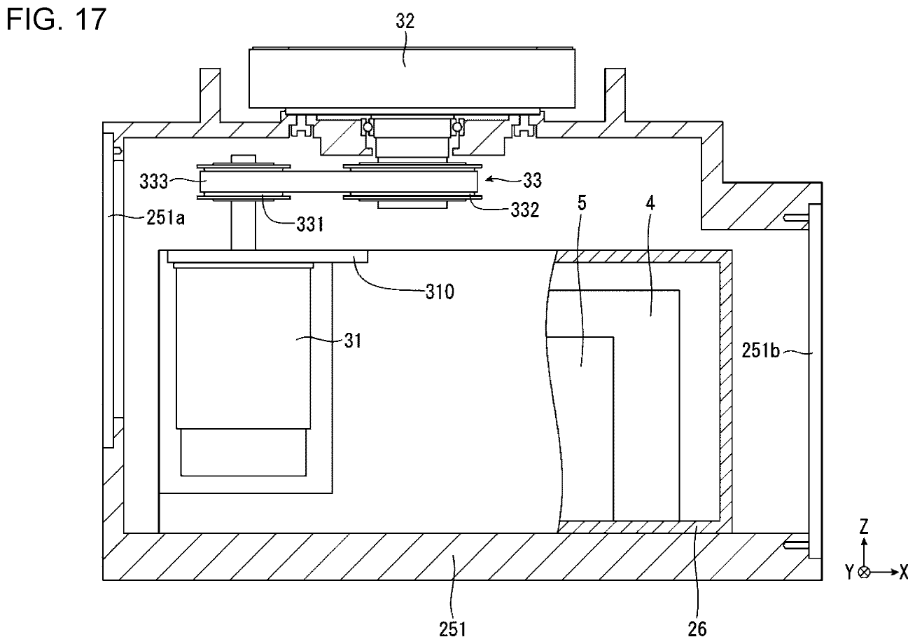

Next, as illustrated in FIG. 16, the inner housing 26 is inserted into the outer housing 25 through the second opening portion 251b. Next, as illustrated in FIG. 17, the belt 333 is wound around the first pulley 331 and the second pulley 332 through the first opening portion 251a. Then, a position of the inner housing 26 is shifted within the outer housing 25, and the tension of the belt 333 is adjusted by changing a distance between the first and second pulleys 331 and 332. According to such a method, the tension of the belt 333 can be easily adjusted. After adjusting the tension of the belt 333, the inner housing 26 is fixed to the outer housing 25 at that position. Finally, the first and second cover members 252 and 253 are attached to the housing body 251. The drive mechanism 3, the control board 4, and the power supply board 5 are attached to the base 21 in this manner.

With the base 21 configured in this manner, the reducer 32 and the motor 31 can be attached and detached separately to and from the base 21 by inserting and removing the inner housing 26 into and from the outer housing 25. As a result, it is easy to perform the assembling, adjustment, and maintenance of the reducer 32 and the motor 31.

As described above, in the robot 1 according to the present embodiment, the inner housing 26 serving as the second housing is housed within the outer housing 25 serving as the first housing. The reducer 32 is attached to the outer housing 25, and the motor 31, the control board 4, and the power supply board 5 are attached to the inner housing 26. With the base 21 configured in this manner, the reducer 32 and the motor 31 can be attached and detached separately from the base 21 by inserting and removing the inner housing 26 into and from the outer housing 25. As a result, it is easy to perform the assembling, adjustment, and maintenance of the reducer 32 and the motor 31.

Further, as described above, the inner housing 26 has a box shape, the control board 4 and the power supply board 5 are housed inside the inner housing 26, and the motor 31 is disposed outside the inner housing 26. With such a configuration, it is possible to effectively protect the control board 4 and the power supply board 5 from moisture and dust. Further, the motor 31 and the reducer 32 can be easily coupled.

As described above, the robot 1 includes a power transmission mechanism 33 that is positioned between the motor 31 and the reducer 32 and transmits a driving force of the motor 31 to the reducer 32. The power transmission mechanism 33 includes the first pulley 331 coupled to the output shaft of the motor 31, the second pulley 332 coupled to an input side of the reducer 32, and the belt 333 wound around the first pulley 331 and the second pulley 332. The tension of the belt 333 is adjusted by adjusting the position of the inner housing 26 relative to the outer housing 25. With such a configuration, the tension of the belt 333 can be easily adjusted.

The second embodiment can also achieve the same effect as the first embodiment.

### Third Embodiment

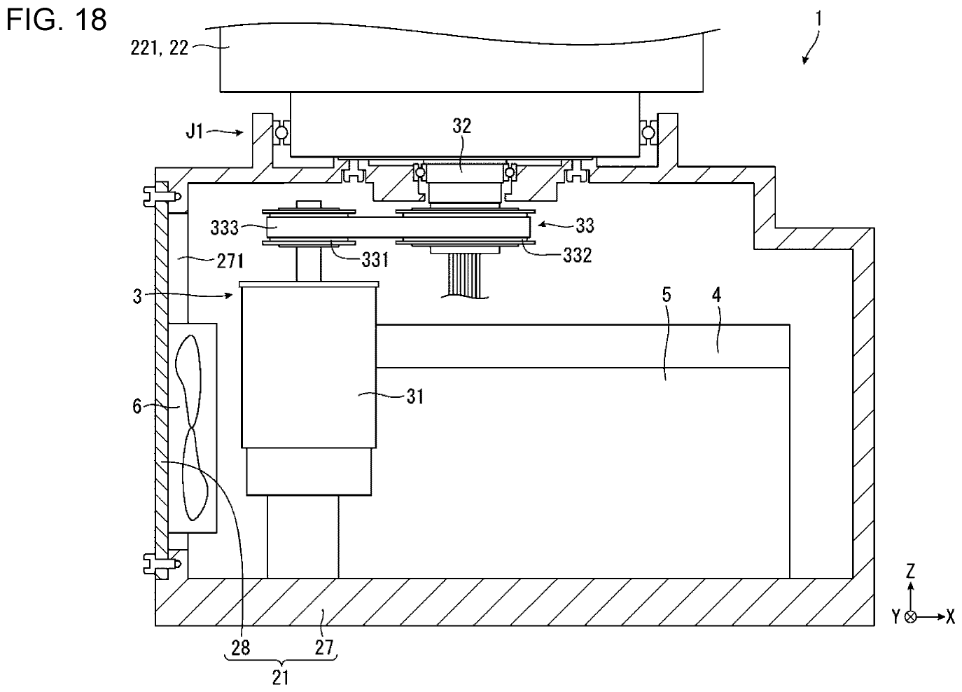

FIG. 18 is a cross-sectional view of a base included in a robot according to a third embodiment.

A robot 1 according to the present embodiment is similar to the above-described robot 1 according to the first embodiment, except that a configuration of a base 21 is different. In the following description, differences between the robot 1 according to the present embodiment and the robot 1 according to the first embodiment described above will be mainly described, and a description of the similar matters will be omitted. In addition, in the drawing of the present embodiment, the same configurations as those in the above-described embodiment are denoted by the same reference numerals.

As illustrated in FIG. 18, the base 21 included the robot 1 according to the present embodiment includes a first housing 27 having an opening portion 271 formed on a front surface of a side wall portion, and a second housing 28 that is attached to the first housing 27 and closes the opening portion 271. A drive mechanism 3, a control board 4, and a power supply board 5 are housed in the first housing 27 and are attached to predetermined portions of the first housing 27. Meanwhile, a fan 6 is fixed to the second housing 28. The fan 6 has a function of blowing air toward the control board 4 and the power supply board 5 for cooling. As the drive mechanism 3, the control board 4, the power supply board 5, and the fan 6 are separately attached to the first housing 27 and the second housing 28 as described above, the drive mechanism 3, the control board 4, the power supply board 5, and the fan 6 can be easily attached and detached.

For example, when assembling the drive mechanism 3 to the base 21, it is sufficient if a step of removing the second housing 28 from the first housing 27, a step of attaching the drive mechanism 3, the control board 4, and the power supply board 5 to the first housing 27 through the opening portion 271, a step of adjusting a position of a motor 31 relative to a reducer 32 to adjust a tension of a belt 333, a step of attaching the fan 6 to the second housing 28, a step of disposing the second housing 28 so as to close the opening portion 271 and inserting the fan 6 into the first housing 27 through the opening portion 271, and a step of screwing the second housing 28 to the first housing 27 are performed. As the drive mechanism 3, the control board 4, the power supply board 5, and the fan 6 are separately attached to the first housing 27 and the second housing 28 as described above, each component can be easily attached and detached while effectively suppressing interference between the components by attaching and detaching the second housing 28 to and from the first housing 27.

In addition, the reducer 32 and the motor 31 are attached to the first housing 27, and thus, alignment thereof can be completed before the second housing 28 is attached to the first housing 27. As a result, it becomes easier to assemble the base 21. Particularly, in the present embodiment, the motor 31 is disposed within the first housing 27 so as to face the opening portion 271. In other words, the motor 31 is disposed on the nearest side when viewed from the opening portion 271 such that no other members are interposed between the motor 31 and the opening portion 271. With such a configuration, it becomes easier to adjust the position of the motor 31 through the opening portion 271, and the tension of the belt 333 can be easily adjusted.

As described above, the robot 1 according to the present embodiment includes the base 21, a robot arm 22 that rotates relative to the base 21, the reducer 32 that couples the base 21 and the robot arm 22, the motor 31 coupled to the reducer 32, the control board 4 that controls the driving of the motor 31, the power supply board 5 that supplies electric power to the control board 4, and the fan 6. The base 21 includes the first housing 27 to which at least one of the reducer 32, the motor 31, the control board 4, the power supply board 5, and the fan 6 is attached, and the second housing 28 to which at least one of the reducer 32, the motor 31, the control board 4, the power supply board 5, and the fan 6 excluding the at least one attached to the first housing 27 is attached. As the reducer 32, the motor 31, the control board 4, the power supply board 5, and the fan 6 are separately attached to the first housing 27 and the second housing 28 as described above, each component can be easily attached and detached while effectively suppressing interference between the components by attaching and detaching the second housing 28 to and from the first housing 27.

As described above, at least the reducer 32 and the motor 31 are attached to the first housing 27, and at least the fan 6 is attached to the second housing 28. With such a configuration, the reducer 32 and the motor 31 are attached to the first housing 27, and thus, alignment thereof can be completed before the second housing 28 is attached to the first housing 27. As a result, it becomes easier to assemble the base 21.

As described above, a power transmission mechanism 33 that couples the motor 31 and the reducer 32 and transmits a driving force of the motor 31 to the reducer 32 is further attached to the first housing 27. The power transmission mechanism 33 includes a first pulley 331 coupled to an output shaft of the motor 31, a second pulley 332 coupled to an input side of the reducer 32, and the belt 333 wound around the first pulley 331 and the second pulley 332. The first housing 27 has the opening portion 271 that is closed by the second housing 28, and the motor 31 faces the opening portion 271. With such a configuration, it becomes easier to adjust the position of the motor 31 through the opening portion 271, and the tension of the belt 333 can be easily adjusted.

The third embodiment can also achieve the same effect as the first embodiment.

The robot 1 according to the present embodiment has been described above, but the configuration of the robot 1 is not limited thereto.

For example, in the present embodiment, the drive mechanism 3, the control board 4, and the power supply board 5 are attached to the first housing 27, and the fan 6 is attached to the second housing 28, but there is no particular limitation as to whether the drive mechanism 3, the control board 4, the power supply board 5, and the fan 6 are attached to the first housing 27 or the second housing 28.

In the present embodiment, the base 21 is divided into the first housing 27 and the second housing 28, but the present disclosure is not limited thereto. For example, the base 21 may be divided into the first housing 27, the second housing 28, and a third housing, and the drive mechanism 3, the control board 4, the power supply board 5, and the fan 6 may be separately attached to the first housing 27, the second housing 28, and the third housing. In other words, the base 21 may include the first housing 27 to which at least one of the reducer 32, the motor 31, the control board 4, the power supply board 5, and the fan 6 is attached, the second housing 28 to which at least one of the reducer 32, the motor 31, the control board 4, the power supply board 5, and the fan 6 excluding the at least one attached to the first housing 27 is attached, and the third housing to which the rest of the reducer 32, the motor 31, the control board 4, the power supply board 5, and the fan 6 is attached. The base 21 may be divided into a greater number of housings including a fourth housing, a fifth housing, and the like.

The robot according to the present disclosure has been described above based on the illustrated embodiments, but the present disclosure is not limited thereto, and a configuration of each part can be replaced with any configuration having a similar function. Any other configuration may be added to the present disclosure. The respective embodiments described above may also be combined as appropriate.

1. A robot comprising:
a base;
a robot arm rotating relative to the base;
a reducer coupling the base and the robot arm;
a motor coupled to the reducer;
a control board controlling driving of the motor; and
a power supply board supplying electric power to the control board,
wherein the base includes a first housing to which at least one of the reducer, the motor, the control board, and the power supply board is attached, and a second housing to which at least one of the reducer, the motor, the control board, and the power supply board excluding the at least one attached to the first housing is attached.

2. The robot according to claim 1, wherein
the control board and the power supply board are attached to the first housing, and
the reducer and the motor are attached to the second housing.

3. The robot according to claim 2, wherein
a power transmission mechanism coupling the motor and the reducer and transmitting a driving force of the motor to the reducer is further attached to the second housing, and
the power transmission mechanism includes a first pulley coupled to an output shaft of the motor, a second pulley coupled to an input side of the reducer, and a belt wound around the first pulley and the second pulley.

4. The robot according to claim 2, wherein
the first housing has an opening portion that is closed by the second housing, and
the reducer and the motor are inserted into the first housing through the opening portion.

5. The robot according to claim 4, wherein the second housing is fixed to the first housing in a state of being mounted on the first housing.

6. The robot according to claim 1, wherein
the second housing is housed in the first housing,
the reducer is attached to the first housing, and
the motor, the control board, and the power supply board are attached to the second housing.

7. The robot according to claim 6, wherein
the second housing has a box shape,
the control board and the power supply board are housed inside the second housing, and
the motor is disposed outside the second housing.

8. The robot according to claim 7, further comprising a power transmission mechanism positioned between the motor and the reducer and transmitting a driving force of the motor to the reducer, wherein
the power transmission mechanism includes a first pulley coupled to an output shaft of the motor, a second pulley coupled to an input side of the reducer, and a belt wound around the first pulley and the second pulley, and
a tension of the belt is adjustable by adjusting a position of the second housing relative to the first housing.

9. A robot comprising:
a base;
a robot arm rotating relative to the base;
a reducer coupling the base and the robot arm;
a motor coupled to the reducer;
a control board controlling driving of the motor;
a power supply board supplying electric power to the control board; and
a fan,
wherein the base includes a first housing to which at least one of the reducer, the motor, the control board, the power supply board, and the fan is attached, and a second housing to which at least one of the reducer, the motor, the control board, the power supply board, and the fan excluding the at least one attached to the first housing is attached.

10. The robot according to claim 9, wherein
at least the reducer and the motor are attached to the first housing, and
at least the fan is attached to the second housing.

11. The robot according to claim 10, wherein
a power transmission mechanism coupling the motor and the reducer and transmitting a driving force of the motor to the reducer is further attached to the first housing,
the power transmission mechanism includes a first pulley coupled to an output shaft of the motor, a second pulley coupled to an input side of the reducer, and a belt wound around the first pulley and the second pulley,
the first housing has an opening portion that is closed by the second housing, and
the motor faces the opening portion.

12. The robot according to claim 1, wherein the reducer is a hollow reducer and includes a wiring that passes through the hollow reducer and is routed between the base and the robot arm.
